(19) United States
(12) Patent Application Publication
(10) Pub. No.: US 2018/0006485 A1
(43) Pub. Date: Jan. 4, 2018

(54) WIRELESS DOCKING MAT FOR ELECTRONIC DEVICES

(71) Applicant: Intel Corporation, Santa Clara, CA (US)

(72) Inventors: Jianfang Zhu, Hillsboro, OR (US); Bo Qiu, Hillsboro, OR (US); Bradley A. Jackson, Hillsboro, OR (US); Sayan Lahiri, Hillsboro, OR (US); James B. Kirkland, JR., Hillsboro, OR (US); Ahmed Omer, Hillsboro, OR (US)

(73) Assignee: Intel Corporation, Santa Clara, CA (US)

(21) Appl. No.: 15/201,418

(22) Filed: Jul. 2, 2016

(51) Int. Cl. H02J 7/02; H02J 50/40; H02J 50/10

(52) U.S. Cl. CPC H02J 7/025; H02J 50/10; H02J 50/40

(57) ABSTRACT

In one example a docking mat for an electronic device comprises a substrate defining a first major surface on which the electronic device may be positioned, a power source coupling, a plurality of power grids embedded in the first major surface and electrically coupled to the power source coupling, wherein a portion of the power grids extend above the first major surface. Other examples may be described.

### BACKGROUND

The subject matter described herein relates generally to the field of electronic devices and more particularly to a wireless docking mat for electronic devices. Wireless docking mats for electronic devices may find utility, e.g., in charging electronic devices.

### BRIEF DESCRIPTION OF THE DRAWINGS

The detailed description is described with reference to the accompanying figures.

FIG. 1 is a high-level schematic illustration of a wireless docking mat adapted for use with an electronic device in accordance with some examples.

FIGS. 2A and 2B are schematic views of a wireless docking mat adapted for use with an electronic device in accordance with some examples.

FIG. 3 is a schematic side view of method to make a wireless docking mat in accordance with some examples.

FIG. 4 is a flowchart illustrating operations in a method to make a wireless docking mat in accordance with some examples.

FIG. 5 is a schematic illustration of an electronic device which may be adapted to implement wireless docking mats in accordance with some examples.

FIGS. 6-10 are schematic illustrations of electronic devices which may be adapted to mate with a wireless docking mat in accordance with some examples.

### DETAILED DESCRIPTION

Described herein are exemplary systems and methods to implement a wireless docking mat in electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

As described above, it may be useful to provide wireless charging systems for electronic device(s). The Open Dots™ alliance provides a specification for a physical and electrical configuration for wireless docking mats. In some examples the subject matter described herein provides a docking mat for an electronic device which comprises a substrate defining a first major surface on which the electronic device may be positioned, a power source coupling, and a plurality of power grids embedded in the first major surface and electrically coupled to the power source coupling, wherein a portion of the power grids extend above the first major surface.

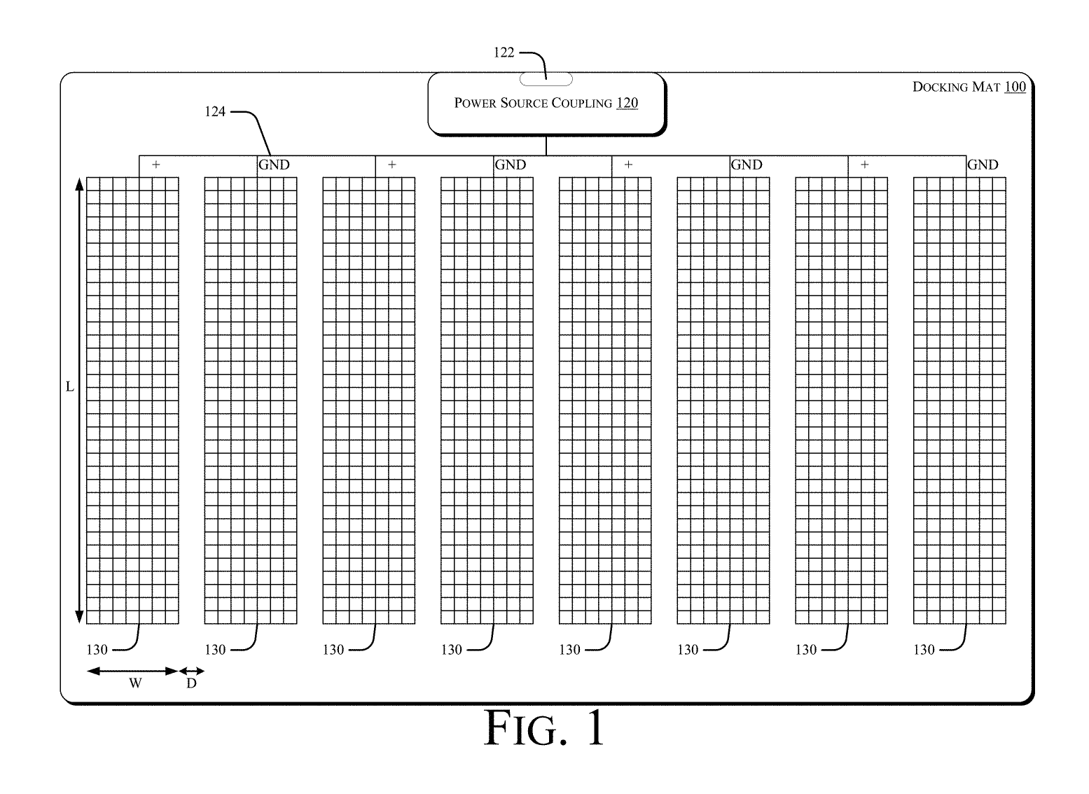

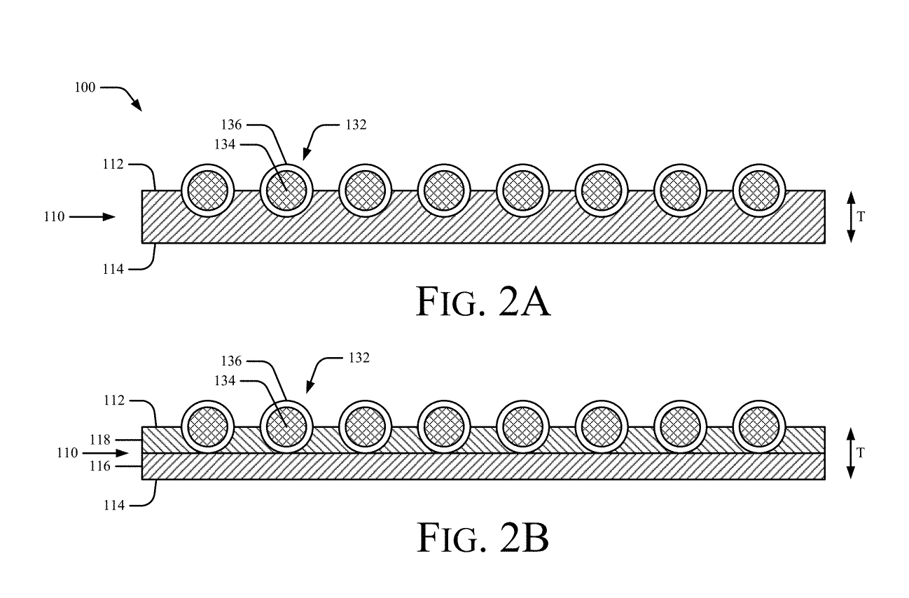

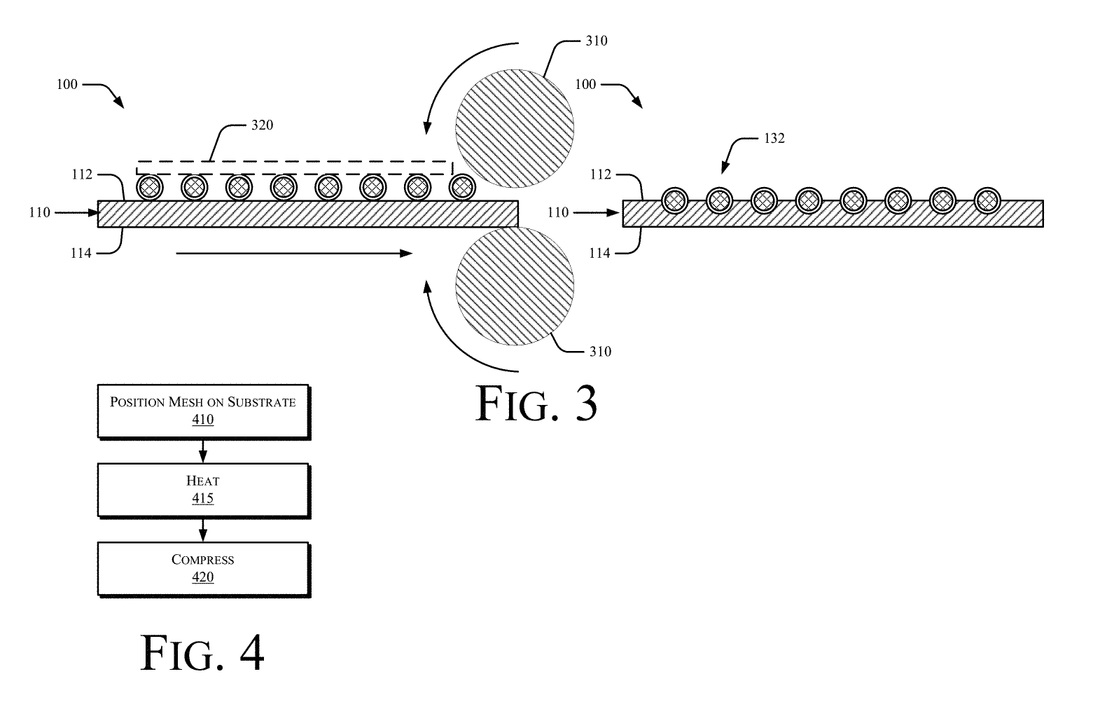

Additional features and operating characteristics of the electronic device and associated system are described below with reference to FIGS. 1-10. Examples of a wireless docking mat will be described with reference to FIGS. 1 and 2A-2B. In some examples a wireless docking mat 100 comprises a substrate 110 defining a first major surface 112 on which the electronic device 500 may be positioned, a power source coupling 120, and a plurality of power grids 130 embedded in the first major surface 112 and electrically coupled to the power source coupling 120.

In some examples the substrate 112 is formed from a substantially translucent material. Examples of materials may include polymers such as polyethylene or rubber. In some examples the substrate has a thickness, T, which measures between 40 microns and 100 microns, and in other examples the thickness T may measure between 50 microns and 60 microns.

In some examples the substrate 110 is a unitary structure, as illustrated in FIG. 2A, while in other examples the substrate 112 comprises a first layer 116 and a second layer 118. The first layer 116 may be formed from a suitable polymer, as described above and the second layer 118 comprises an anti-corrosion material.

In some examples the power source coupling 120 comprises an input port 122 to receive power from an external source. For example, the input port 122 may be configured to receive power from a Universal Serial Bus (USB) connection, a direct current (DC) power source, or an alternating current (AC) power source. In further examples the power source coupling 120 may comprise one or more wireless power receivers, e.g., an inductive coil or a capacitive plate, to receive power wirelessly from a wireless power transmitter.

In some examples a power distribution grid 124 is coupled to the power source coupling 120 to provide power to the plurality of power grids 130. The power distribution grid 124 may be implemented as a plurality of separate circuits from the power source coupling 120 and the respective power grids 130.

In some examples the plurality of power grids 130 are formed from wires 132 comprising a copper core 134 and a nickel coating 236 over at least a portion of the copper core 234. In some examples the wires 132 measure between 20 micrometers and 60 micrometers in diameter, while in other examples the wires 132 measure between 40 micrometers and 50 micrometers in diameter.

In some examples each of the plurality of power grids 130 measures between 0.5 centimeters and 1.5 centimeters in width, indicated by W in FIG. 1, and adjacent power grids 230 are separated by a distance adequate to electrically isolate adjacent power grids 130 which measures between 1 millimeter and 5 millimeters, indicated by D in FIG. 1. Further each of the plurality of power grids 130 measures between 5 centimeters and 20 centimeters in length, as indicated by L in FIG. 1.

Having described structural components of a docking mat 100, various operations in a method to make a docking mat will be described with reference to FIGS. 3 and 4. In some examples the power grids 130 and the power distribution grid 124 may be formed as a mesh using conventional metal forming processes. For example, the copper cores 134 may be printed using conventional circuit printing processes, then the nickel coating 136 may be applied using electroplating, spray coating, dipping techniques, or the like. The wires may be formed at a pitch of up to eighty (80) lines per inch.

Referring to FIG. 4, at operation 410 the power grids 130 are positioned on the substrate. In the case of pre-formed mesh power grids 130 the power grids 130 and the power distribution grid 124 may be placed on the substrate manually or by automated equipment. In other examples the power grids 130 may be printed directly on the substrate 110 using conventional circuit trace printing technology.

At operation 415 heat is applied to soften the substrate 110. In some examples the mat 100 may be placed into a heated enclosure, while in other examples the mat 100 may be heated by directing radiation or ultrasound waves onto the substrate 110. In some examples the substrate 110 may be heated to a temperature between 100° C. and 140° C.

At operation 420 the substrate 110 is between rollers 310 to embed the power grid 130 and the power distribution grid 124 into the substrate 110. In some examples a plate 320 may be used to cover the power grid 130 and the power distribution grid 124 in order to ensure an even pressure distribution during the rolling process. The power grid 130 and the power distribution grid 124 may be embedded such that approximately fifty percent of the wires 132 are embedded into the substrate.

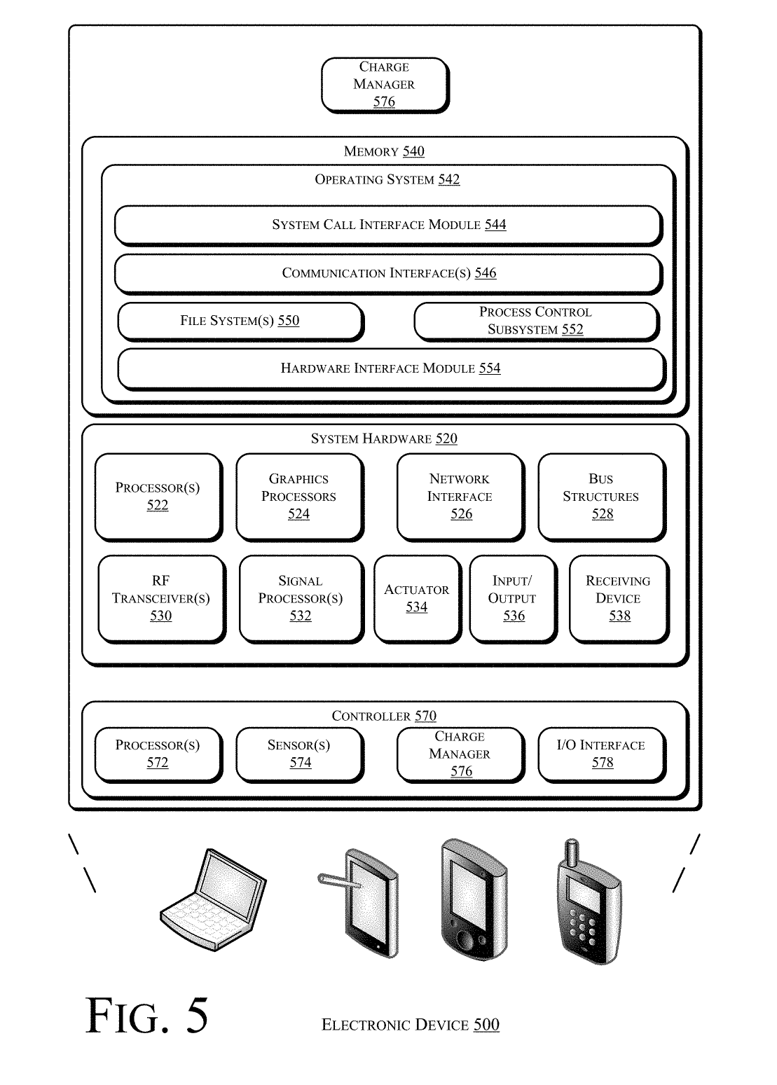

FIG. 5 is a schematic illustration of an electronic device 500 which may be adapted to work with a docking mats in accordance with some examples. In various examples, electronic device 500 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 500 to receive input from a user.

The electronic device 500 includes system hardware 520 and memory 540, which may be implemented as random access memory and/or read-only memory. A file store may be communicatively coupled to electronic device 500. The file store may be internal to electronic device 500 such as, e.g., eMMC, SSD, one or more hard drives, or other types of storage devices. Alternatively, the file store may also be external to electronic device 500 such as, e.g., one or more external hard drives, network attached storage, or a separate storage network.

System hardware 520 may include one or more processors 522, graphics processors 524, network interfaces 526, and bus structures 528. In one embodiment, processor 522 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 524 may function as adjunct processor that manages graphics and/or video operations. Graphics processor(s) 524 may be integrated onto the motherboard of electronic device 500 or may be coupled via an expansion slot on the motherboard or may be located on the same die or same package as the Processing Unit.

In one embodiment, network interface 526 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 528 connect various components of system hardware 528. In one embodiment, bus structures 528 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 500 may include an RF transceiver 530 to transceive RF signals, and a signal processing module 532 to process signals received by RF transceiver 530. RF transceiver may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 500 may further include one or more power storage devices 534, e.g., batteries, and one or more input/output interfaces 536 such as, e.g., a keypad and/or a display. In some examples electronic device 500 may not have a keypad and use the touch panel for input.

Electronic device 500 may further include at least one wireless power receiving device 538 to receive power via an electromagnetic coupling with a driven coil in a charging device. The wireless power receiving device 538 may comprise one or more coil(s) to receive power through an inductive coupling with a driven coil or coupling charge plate(s) to receive power through a capacitive coupling with a driven capacitor in the charging device.

Memory 540 may include an operating system 542 for managing operations of electronic device 500. In one embodiment, operating system 542 includes a hardware interface module 554 that provides an interface to system hardware 520. In addition, operating system 540 may include a file system 550 that manages files used in the operation of electronic device 500 and a process control subsystem 552 that manages processes executing on electronic device 500.

Operating system 542 may include (or manage) one or more communication interfaces 546 that may operate in conjunction with system hardware 520 to send and/or receive data packets and/or data streams from a remote source. Operating system 542 may further include a system call interface module 544 that provides an interface between the operating system 542 and one or more application modules resident in memory 540. Operating system 542 may be embodied as a UNIX operating system or any derivative thereof (e.g., Linux, Android, etc.) or as a Windows® brand operating system, or other operating systems.

In some examples an electronic device may include a controller 570, which may comprise one or more controllers that are separate from the primary execution environment. The separation may be physical in the sense that the controller may be implemented in controllers which are physically separate from the main processors. Alternatively, the trusted execution environment may logical in the sense that the controller may be hosted on same chip or chipset that hosts the main processors.

By way of example, in some examples the controller 570 may be implemented as an independent integrated circuit located on the motherboard of the electronic device 500, e.g., as a dedicated processor block on the same SOC die. In other examples the trusted execution engine may be implemented on a portion of the processor(s) 522 that is segregated from the rest of the processor(s) using hardware enforced mechanisms

In the embodiment depicted in FIG. 5 the controller 570 comprises a processor 572, a sensor 574, a charge manager 576, and an I/O interface 578. In some examples sensor(s) 574 may include a wireless communication capability to detect the presence of electronic device 500. The I/O module 578 may comprise a serial I/O module or a parallel I/O module. Because the controller 570 is separate from the main processor(s) 522 and operating system 542, the controller 570 may be made secure, i.e., inaccessible to hackers who typically mount software attacks from the host processor 522. In some examples portions of the charge manager 576 may reside in the memory 540 of electronic device 500 and may be executable on one or more of the processors 522.

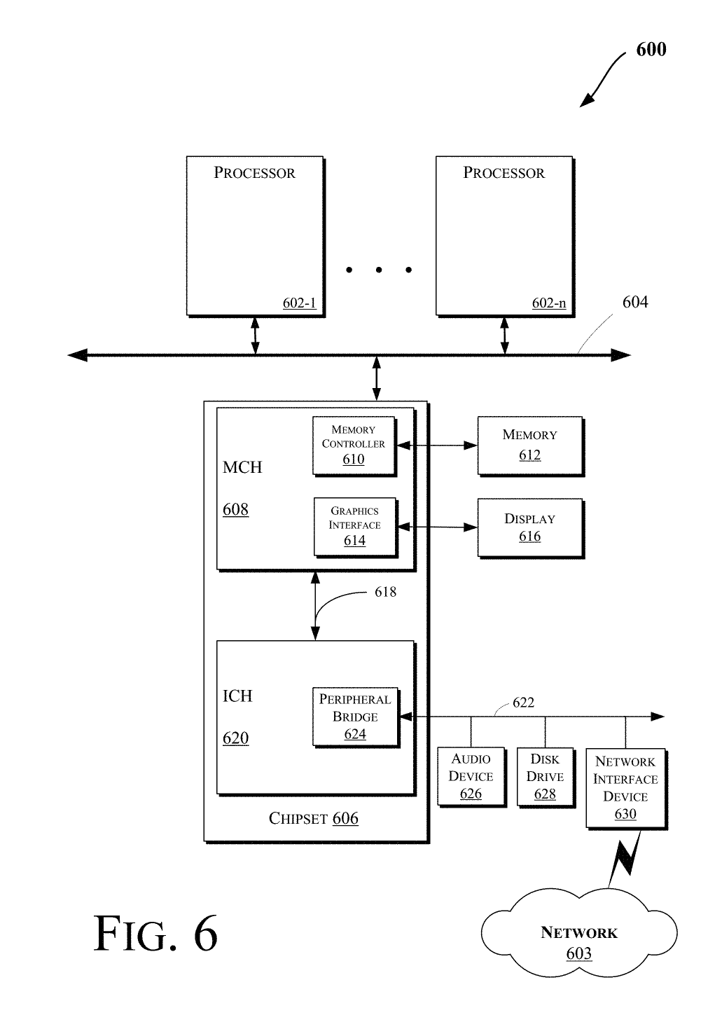

As described above, in some examples the electronic device may be embodied as an information processing system. FIG. 6 illustrates a block diagram of an information processing system 600 in accordance with an example. The information processing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors.

A chipset 606 may also communicate with the interconnection network 604. The chipset 606 may include a memory control hub (MCH) 608. The MCH 608 may include a memory controller 610 that communicates with a memory 612. The memory 412 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the information processing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

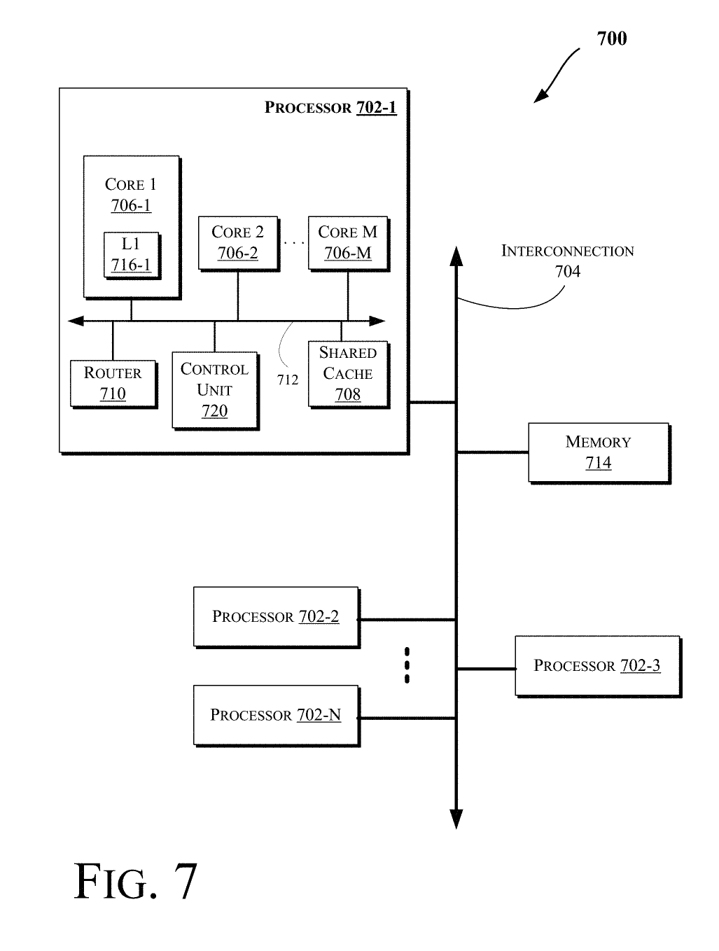

FIG. 7 illustrates a block diagram of an information processing system 700, according to an example. The information processing system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”).

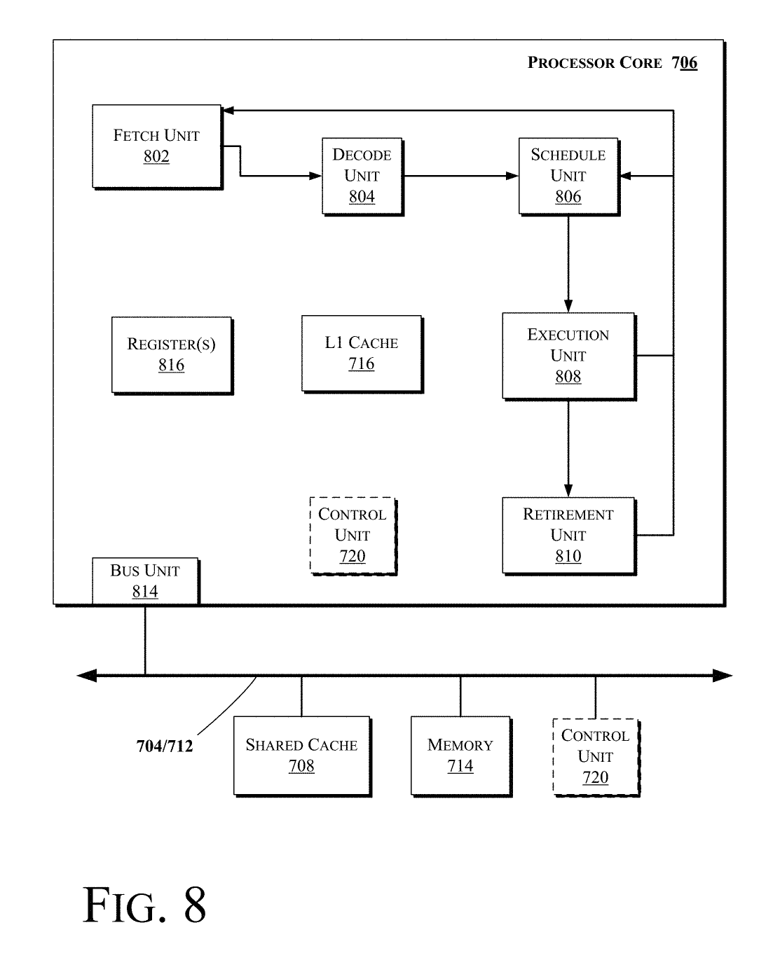

FIG. 8 illustrates a block diagram of portions of a processor core 706 and other components of an information processing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of micro-operations.

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

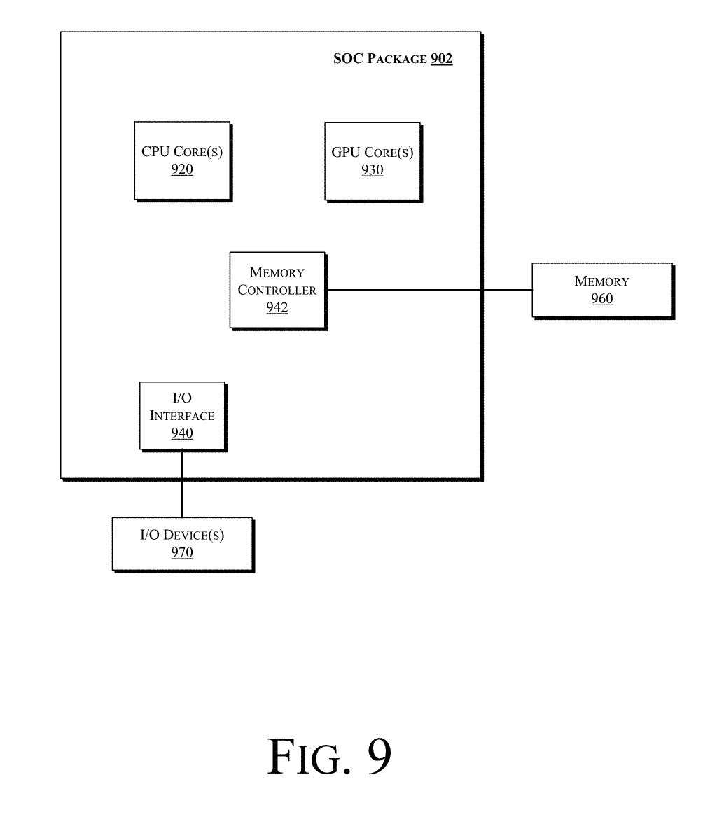

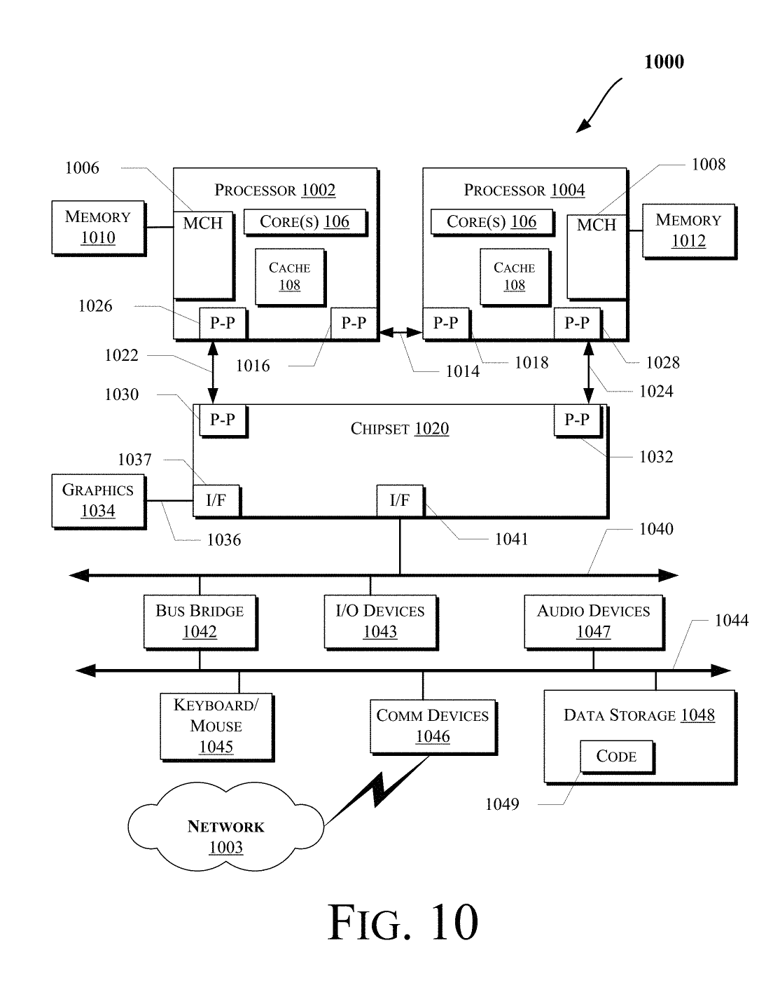

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

FIG. 10 illustrates an information processing system 1000 that is arranged in a point-to-point (PtP) configuration, according to an example. In particular, FIG. 10 shows a system where processors, memory, and input/output devices are interconnected by a number of point-to-point interfaces.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following pertains to further examples.

Example 1 is a docking mat for an electronic device, comprising a substrate defining a first major surface on which the electronic device may be positioned, a power source coupling; and a plurality of power grids embedded in the first major surface and electrically coupled to the power source coupling, wherein a portion of the power grids extend above the first major surface.

In Example 2, the subject matter of Example 1 can optionally include an arrangement wherein the substrate is formed from a substantially translucent polymer.

In Example 3, the subject matter of any one of Examples 1-2 can optionally include an arrangement wherein the substrate has a thickness, T, which measures between 40 microns and 100 microns.

In Example 4, the subject matter of any one of Examples 1-3 can optionally include an arrangement wherein the substrate comprises a first layer and a second layer.

In Example 5, the subject matter of any one of Examples 1-4 can optionally include an arrangement wherein the second layer comprises an anti-corrosion material.

In Example 6, the subject matter of any one of Examples 1-5 can optionally include an arrangement wherein the power source coupling comprises an input port to receive power from an external source.

In Example 7, the subject matter of any one of Examples 1-6 can optionally include a power distribution grid to couple the power source coupling to the plurality of power grids.

In Example 8, the subject matter of any one of Examples 1-7 can optionally include an arrangement wherein the plurality of power grids are arranged in alternating polarities on the first surface.

In Example 9, the subject matter of any one of Examples 1-8 can optionally include an arrangement wherein the plurality of power grids are formed from wires comprising a copper core and a nickel coating over at least a portion of the copper core.

In Example 10, the subject matter of any one of Examples 1-9 can optionally include an arrangement wherein the wires measure between 20 and 60 micrometers in diameter.

In Example 11, the subject matter of any one of Examples 1-10 can optionally include an arrangement wherein the plurality of power grids are separated by a distance adequate to electrically isolate adjacent power grids.

In Example 12, the subject matter of any one of Examples 1-11 can optionally include an arrangement wherein each of the plurality of power grids measures between 0.5 centimeters and 1.5 centimeters in width and adjacent power grids are separated by a distance which measures between 1 millimeter and 5 millimeters.

In Example 13, the subject matter of any one of Examples 1-12 can optionally include an arrangement wherein each of the plurality of power grids measures between 5 centimeters and 20 centimeters in length.

Example 14 is a method to make a docking mat for an electronic device, comprising embedding a plurality of power grids in a first major surface of a substrate; and electrically coupling the power grids to a power source coupling, wherein a portion of the power grids extend above the first major surface.

In Example 15, the subject matter of Example 14 can optionally include an arrangement wherein embedding a plurality of power grids in the first major surface of the substrate comprises heating the substrate to a temperature between 100° C. and 140° C.

In Example 16, the subject matter of any one of Examples 14-15 can optionally include an arrangement wherein embedding a plurality of power grids in the first major surface of the substrate comprises compressing the substrate between rollers.

In Example 17, the subject matter of any one of Examples 14-16 can optionally include an arrangement wherein the substrate is formed from a substantially translucent polymer.

In Example 18, the subject matter of any one of Examples 14-17 can optionally include an arrangement wherein the substrate has a thickness, T, which measures between 40 microns and 100 microns.

In Example 19, the subject matter of any one of Examples 14-18 can optionally include an arrangement wherein the substrate comprises a first layer and a second layer.

In Example 20, the subject matter of any one of Examples 14-19 can optionally include an arrangement wherein the second layer comprises an anti-corrosion material.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A docking mat for an electronic device, comprising:
a substrate defining a first major surface on which the electronic device may be positioned;
a power source coupling; and
a plurality of power grids embedded in the first major surface and electrically coupled to the power source coupling, wherein a portion of the power grids extend above the first major surface.

2. The docking mat of claim 1, wherein the substrate is formed from a substantially translucent polymer.

3. The docking mat of claim 1, wherein the substrate has a thickness, T, which measures between 40 microns and 100 microns.

4. The docking mat of claim 1, wherein the substrate comprises a first layer and a second layer.

5. The docking mat of claim 4, wherein the second layer comprises an anti-corrosion material.

6. The docking mat of claim 1, wherein the power source coupling comprises an input port to receive power from an external source.

7. The docking mat of claim 6, further comprising a power distribution grid to couple the power source coupling to the plurality of power grids.

8. The docking mat of claim 7, wherein the plurality of power grids are arranged in alternating polarities on the first surface.

9. The docking mat of claim 1, wherein the plurality of power grids are formed from wires comprising a copper core and a nickel coating over at least a portion of the copper core.

10. The docking mat of claim 9, wherein:
the wires measure between 20 and 60 micrometers in diameter.

11. The docking mat of claim 1, wherein the plurality of power grids are separated by a distance adequate to electrically isolate adjacent power grids.

12. The docking mat of claim 1, wherein each of the plurality of power grids measures between 0.5 centimeters and 1.5 centimeters in width and adjacent power grids are separated by a distance which measures between 1 millimeter and 5 millimeters.

13. The docking mat 100 of claim 12, wherein each of the plurality of power grids measures between 5 centimeters and 20 centimeters in length.

14. A method to make a docking mat for an electronic device, comprising:
embedding a plurality of power grids in a first major surface of a substrate; and
electrically coupling the power grids to a power source coupling,
wherein a portion of the power grids extend above the first major surface.

15. The method of claim 14, wherein embedding a plurality of power grids in the first major surface of the substrate comprises:
heating the substrate to a temperature between 100° C. and 140° C.

16. The method of claim 15, wherein embedding a plurality of power grids in the first major surface of the substrate comprises:
compressing the substrate between rollers.

17. The method of claim 14, wherein the substrate is formed from a substantially translucent polymer.

18. The method of claim 14, wherein the substrate has a thickness, T, which measures between 40 microns and 100 microns.

19. The method of claim 14, wherein the substrate comprises a first layer and a second layer.

20. The method of claim 14, wherein the second layer comprises an anti-corrosion material.
